(19) United States
(12) Patent Application Publication
(10) Pub. No.: US 2010/0107367 A1
(43) Pub. Date: May 6, 2010

(54) ROTARY HINGE MODULE AND FOLDER TYPE MOBILE COMMUNICATION TERMINAL HAVING THE SAME

(75) Inventor: Joo Yon JUNG, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/582,913

(22) Filed: Oct. 21, 2009

(30) Foreign Application Priority Data
Nov. 3, 2008 (KR) 10-2008-0108462

(51) Int. Cl. E05F 1/08; E05D 11/10

(52) U.S. Cl. 16/297; 16/303

(57) ABSTRACT

A rotary hinge module with a hinge holder having a housing with a receiving space, a first elastic member and a cam member accommodated in the receiving space of the hinge holder, and a rotary shaft vertically movably provided in the receiving space, the rotary shaft passing through the first elastic member, the cam member, and the receiving space. The cam member and the receiving space to be rotatable, and the rotary shaft has a rotating cam which contacts and corresponds to the cam member. The rotary hinge module is applied to a folder type mobile communication terminal.

### CROSS-REFERENCE TO RELATED APPLICATION

This application claims priority from and the benefit of Korean Patent Application No. 10-2008-0108462, filed on Nov. 3, 2008, which is hereby incorporated by reference for all purposes as if fully set forth herein.

### BACKGROUND OF THE INVENTION

1. Field of the Invention

The present invention relates to a rotary hinge module and a folder type mobile communication terminal having the same, and more particularly to a hinge module allowing a rotating movement as well as a basic folding movement, and a folder type mobile communication terminal having such a hinge module.

2. Discussion of the Background

Generally, mobile communication terminals may be classified into bar type terminals, flip type terminals, and folder type terminals, in aspect of their appearances.

A bar type terminal has one body housing in which data input/output (I/O) units and transceiver modules are mounted. However, the bar type terminal may suffer from malfunction of its keypad since the keypad serving as a data input means is always exposed to the outside. Also, the bar type terminal may not be easily designed into a small size since its transmitter and receiver should be spaced apart by a predetermined distance.

A flip type terminal includes a body, a flip and a hinge module connecting the body to the flip. A data I/O unit and a transceiver module are mounted at the body of the flip type terminal, and the flip covers a keypad serving as the data I/O unit. Thus, it is possible to reduce malfunction of the keypad. However, the flip type terminal also has a limitation that it cannot be easily designed to a small size since a sufficient distance should be ensured between the transmitter and the receiver.

A folder type terminal includes a body, a folder and a hinge module connecting the body with the folder, and the folder is opened or closed by unfolding or folding the folder from/to the body with respect to the hinge module. Generally, a data input unit such as a keypad is provided at the body. In a standby state, the folder is closely arranged to the body, so any malfunction of the keypad may be reduced. And, in a call mode, the folder is unfolded from the body with respect to the hinge module, so that a sufficient distance may be ensured between a transmitter and a receiver, which permits a terminal to be manufactured with a smaller size.

The hinge module of the flip type terminal or the folder type terminal is configured to allow a folding or unfolding movement of the folder from/to the body, i.e. a folder movement.

There are some types of proposed folder type terminals, which allow a rotating movement as well as a folding movement, but such terminals are provided with one hinge module for the folding movement and a separate hinge module for the rotating movement. Thus, during a rotating movement, the folder may be nearly entirely separated from the body. Further, in the above terminals, after the folder makes a rotating movement (e.g., 180 degrees rotation), the folder and the body do not make a constant slope, so the terminal may not be stably placed on a table or the like. Thus, a user should grip or handle the terminal in order to watch a moving picture or the like on a screen of the terminal.

### SUMMARY OF THE INVENTION

Exemplary embodiments of the present invention provide a rotary hinge module compatible for various specifications and designs of mobile communication terminals, and a folder type mobile communication terminal having the rotary hinge module.

Additional features of the invention will be set forth in the description which follows, and in part will be apparent from the description, or may be learned by practice of the invention.

An exemplary embodiment of the present invention discloses a rotary hinge module, comprising a hinge holder comprising a housing with a receiving space; a first elastic member and a cam member disposed in the receiving space of the hinge holder; and a rotary shaft disposed in the receiving space, the rotary shaft disposed through the first elastic member, the cam member, and the receiving space to be rotatable and vertically moveable, wherein the rotary shaft has a rotating cam which is disposed on and corresponds to the cam member.

An exemplary embodiment of the present invention also discloses a folder type mobile communication terminal, comprising a body; a folder; and a rotary hinge module installed at a portion where the body contacts the folder, wherein the rotary hinge module comprises a hinge holder comprising a housing with a receiving space; a first elastic member and a cam member disposed in the receiving space of the hinge holder; and a rotary shaft disposed in the receiving space, the rotary shaft disposed through the first elastic member, the cam member, and the receiving space to be rotatable and vertically moveable, wherein the rotary shaft has a rotating cam which is disposed on and corresponds to the cam member, and wherein an upper portion of the rotary shaft is disposed in the folder to allow a folding movement and a rotating movement of the body and the folder.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a perspective view showing a rotary hinge module according to an exemplary embodiment of the present invention.

FIG. 2 is an exploded perspective view showing the rotary hinge module according to an exemplary embodiment of the present invention.

FIG. 3 is a sectional view showing the rotary hinge module according to an exemplary embodiment of the present invention.

FIG. 4A is a perspective view showing a folder type mobile communication terminal according to an exemplary embodiment of the present invention.

FIG. 4B is a partially enlarged sectional view of FIG. 4A.

FIG. 5A is a perspective view showing the folder type mobile communication terminal according to an exemplary embodiment of the present invention, in which a folder is opened by 90 degrees.

FIG. 5B is a partially enlarged sectional view of FIG. 5A.

FIG. 6A is a perspective view showing the folder type mobile communication terminal according to an exemplary embodiment of the present invention, in which the folder is opened by 180 degrees.

FIG. 6B is a partially enlarged sectional view of FIG. 6A.

FIG. 7A is a perspective view showing the folder type mobile communication terminal according to an exemplary embodiment of the present invention, in which the folder is rotated by 90 degrees.

FIG. 7B is a partially enlarged sectional view of FIG. 7A.

FIG. 8A is a perspective view showing the folder type mobile communication terminal according to an exemplary embodiment of the present invention, in which the folder is rotated by 180 degrees.

FIG. 8B is a partially enlarged sectional view of FIG. 8A.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “coupled” or “on” another element, it can be directly on or directly connected to the other element, or intervening elements may be present. In contrast, when an element is referred to as being “directly on” or “directly coupled to” another element, there are no intervening elements present.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

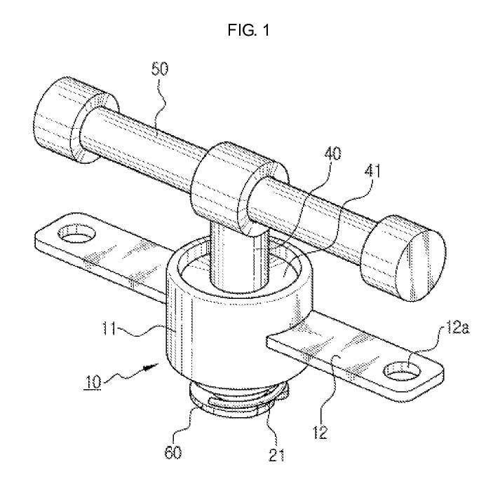

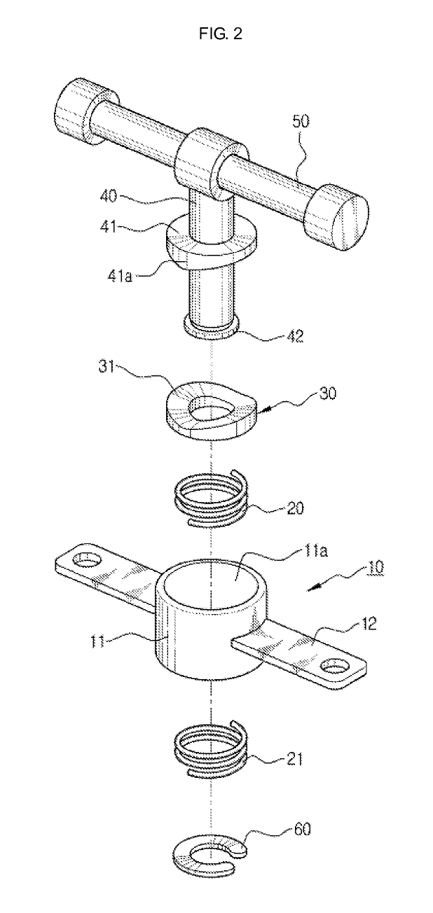

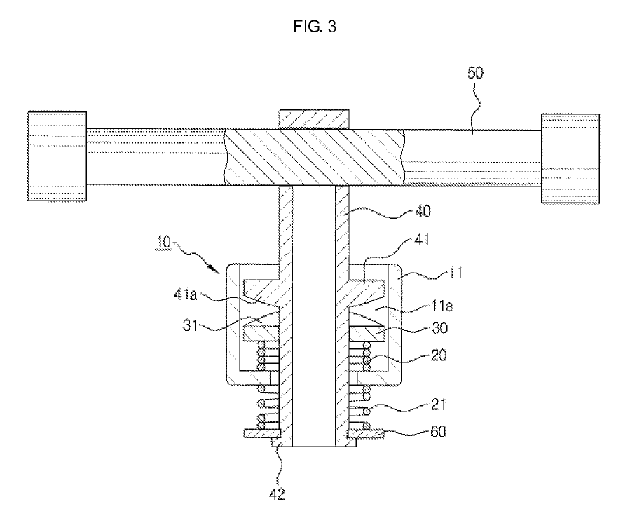

FIG. 1 is a perspective view showing a rotary hinge module according to an exemplary embodiment of the present invention, FIG. 2 is an exploded perspective view showing the rotary hinge module of FIG. 1, and FIG. 3 is a sectional view showing the rotary hinge module of FIG. 1.

Referring to FIG. 1, FIG. 2, and FIG. 3, a rotary hinge module includes a hinge holder 10, which has a housing 11 with a receiving space 11a, and connection members 12 extending from both sides of the housing 11 and fixed thereto. An elastic member 20 and a cam member 30 are accommodated in the receiving space 11a of the hinge holder 10. A rotary shaft 40 is provided through the elastic member 20, the cam member 30, and the receiving space 11a, and the rotary shaft 40 is vertically movable in the receiving space 11a and rotatable with respect to the elastic member 20, the cam member 30, and the receiving space 11a. A support 50 is coupled to an upper portion of the rotary shaft 40.

A coupling hole 12a is respectively formed in the connection member 12, such that the hinge holder 10 may be fixed in a body with a coupling member.

As shown in FIG. 3, an elastic member 21 is provided at a lower portion of the rotary shaft 40 located out of and below the receiving space 11a of the hinge holder 10, and a ring member 60 is provided below the elastic member 21.

A rotating cam 41 is formed at the rotary shaft 40 corresponding to the cam member 30, and the rotating cam 41 contacts the cam member 30.

A protrusion 31 and a protrusion 41a are respectively formed on the cam member 30 and the rotating cam 41.

Also, a circular projection 42 is formed at a lower end of the rotary shaft 40 to support the ring member 60 and the elastic member 21 while the rotary shaft 40 is inserted therein.

The hinge module of this exemplary embodiment may be applied to a mobile communication terminal, particularly a folder type mobile communication terminal.

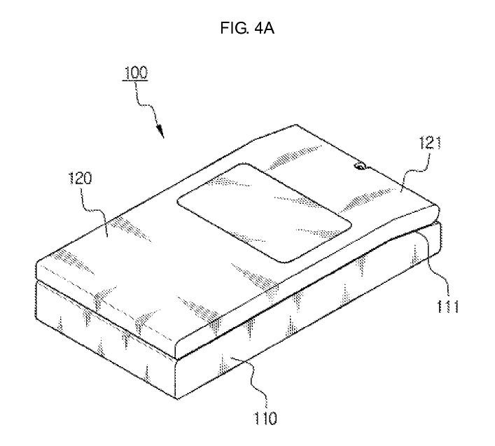

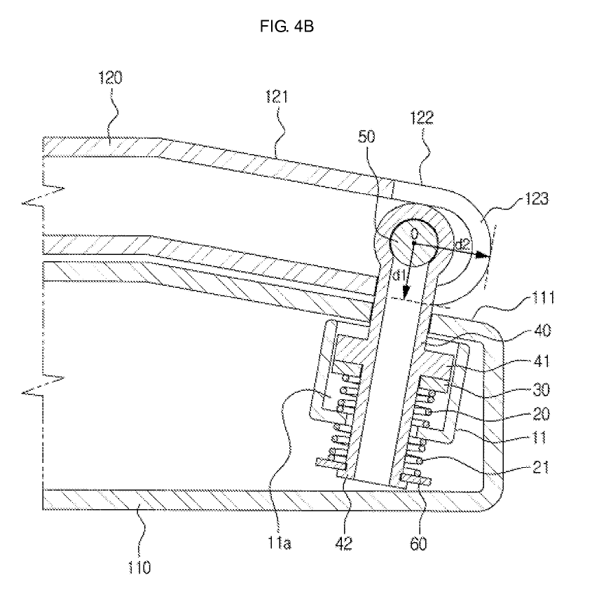

In more detail, as shown in FIG. 4A and FIG. 4B, the hinge module is installed at a contact portion of a body 110 and a folder 120 of a folder type mobile communication terminal 100. The body 110 includes a hinge holder 10, elastic members 20, 21, a cam member 30, and a ring member 60 therein. An upper portion of a rotary shaft 40 that passes through a receiving space 11a in the housing 11 of the hinge holder 10 extends to the folder 120 through the body 110. A support 50 coupled to an upper end of the rotary shaft 40 is also provided in the folder 120.

Inclined surfaces 111, 121 are respectively arranged at contact portions between the body 110 and the folder 120.

As shown in FIG. 4B, the folder 120 has an end with a curved surface 123, which has a second radius d2 greater than a first radius d1 that is a distance from a center O of the support 50 to a linear surface 122 of the folder 120. In other words, the curved surface 123 has a semicircular shape.

When the folder 120 is already rotated in one direction, continuing to rotate the folder 120 in that same direction successively may cause wirings or the like in the folder 120 to be twisted. Since the folder 120 is intended to be rotated back to its original position without causing this wirings or the like in the folder 120 to be twisted, the body 110 may have a stopper such as a projection at a certain position therein such that the folder 120 may not be rotated further in the same direction after being rotated by a certain angle. The folder type mobile communication terminal 100 of this exemplary embodiment may have an extension at one side of the rotary shaft 40 such that the folder 120 may not be rotated past a certain angle since the projection obstructs the rotation. However, this configuration may be modified into various structures or shapes, not limited to the above.

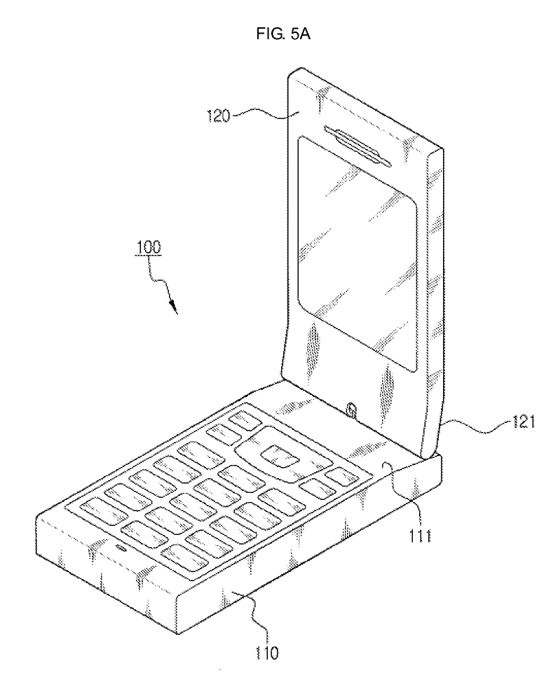

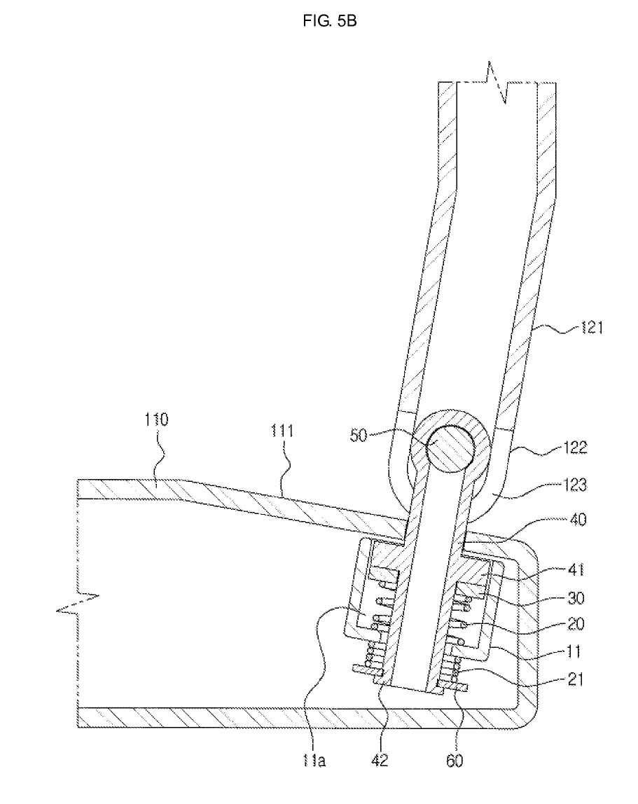

FIG. 5A and FIG. 5B illustrate that the folder 120 is opened with respect to the body 110, and an end of the folder 120 is configured vertically with respect to an end of the body 110. Referring to FIG. 5B, the folder 120 has a semicircular end in its section as mentioned above, and the second radius d2 from the center of the support 50 to the curved surface 123 is greater than the first radius d1 from the center of the support 50 to the linear surface 122. Thus, if the folder 120 is configured in a vertical direction, the rotary shaft 40 is lifted up by a difference in length between the second radius d2 and the first radius d1.

As the rotary shaft 40 moves up, the ring member 60 hooked up and supported by the projection 42 formed at the lower end of the rotary shaft 40 is also moved up to compress the elastic member 21. If the rotary shaft 40 moves up, the rotating cam 41 of the rotary shaft 40 in contact with the cam member 30 is also moved up. This causes the elastic member 20 elastically supported at a lower portion of the cam member 30 to expand, and the cam member 30 is also moved up due to a repulsive force against the elastic member 20, so the cam member 30 continuously remains in contact with the rotating cam 41 of the rotary shaft 40.

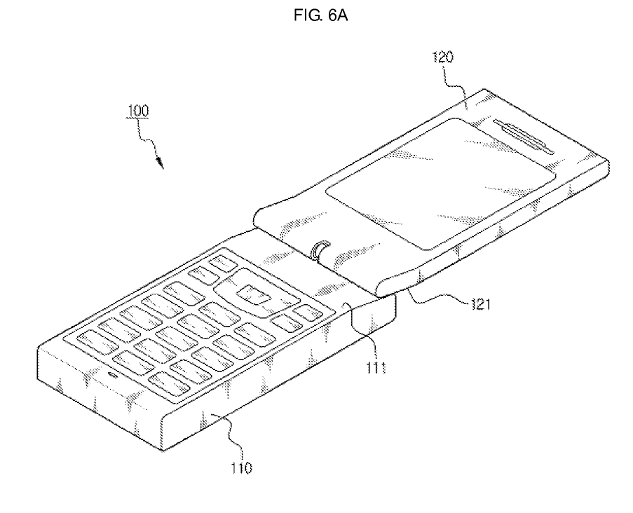

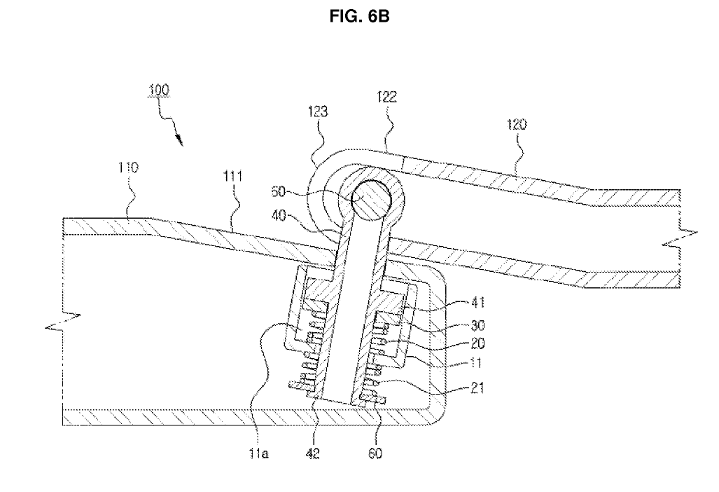

In this state, as shown in FIG. 6A and FIG. 6B, if the folder 120 is completely unfolded and in a substantially horizontal state with the body 110, the lifted rotary shaft 40 is moved down again. In other words, as the linear surface 122 of the folder 120 encounters the inclined surface 111 of the body 110 again, the radius is decreased, so the rotary shaft 40 moves down.

At this time, the rotary shaft 40 moves down more rapidly with the assistance of the compressed elastic member 21. If the rotating cam 41 of the rotary shaft 40 moves down, the cam member 30 arranged below is also moved down along a length direction of the rotary shaft 40, so the elastic member 20 provided in the housing 11 is compressed.

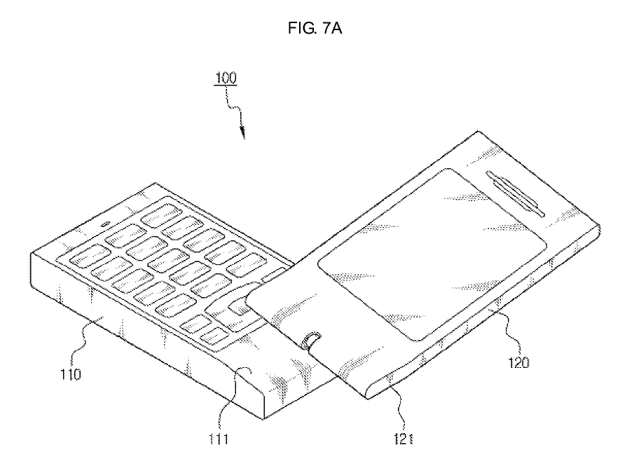

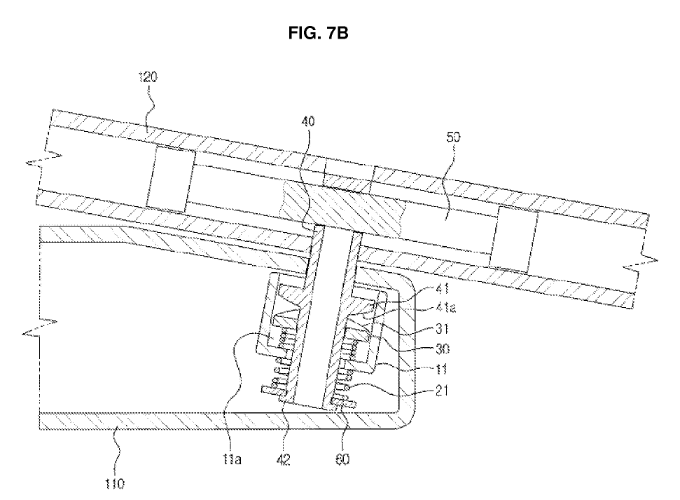

If a user rotates the opened folder 120 (by 90 degrees) for watching a moving picture or the like as shown in FIG. 7A and FIG. 7B, the rotary shaft 40 provided in the body 110 is rotated with respect to the hinge holder 10. The upper end of the rotary shaft 40 is coupled with the support 50 that is provided in the folder 120 and extended and fixed in a width direction of the folder 120. Thus, if the folder 120 is rotated, the support 50 is rotated, and accordingly the rotary shaft 40 is rotated together.

As shown in FIG. 7B, if the rotary shaft 40 is rotated, the rotating cam 41 formed at the rotary shaft 40 is rotated, and the protrusion 41a formed on the rotating cam 41 and the protrusion 31 of the cam member 30, arranged to cross each other, encounter each other. Thus, the cam member 30 moves down by a protruding height of the protrusion 41a formed on the rotating cam 41 and the protrusion 31 of the cam member 30, thereby compressing the elastic member 20. At this time, the rotary shaft 40 receives a downward force due to the elastic member 21 located out of and below the housing 11, so the folder 120 keeps its location without freely moving due to the downward force.

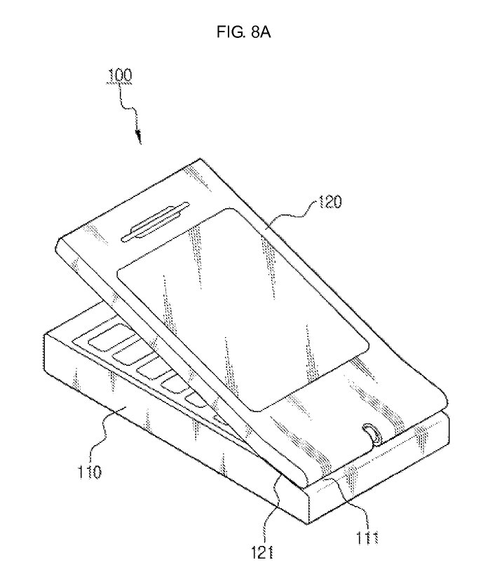

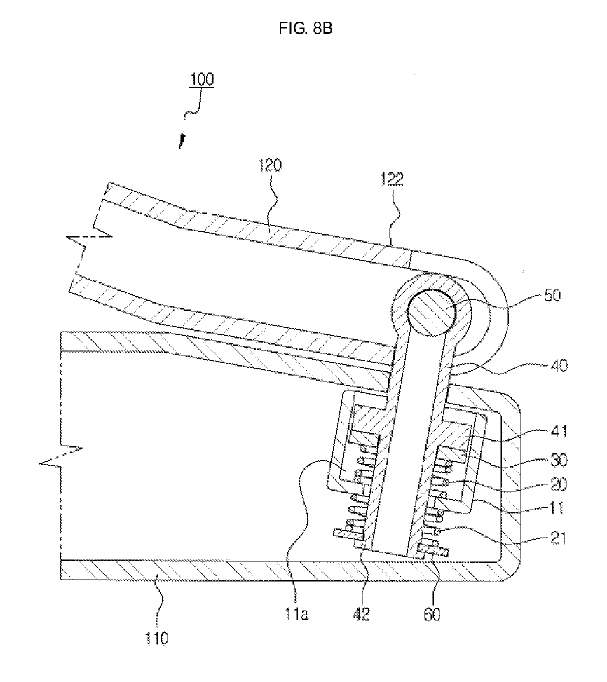

In this state, if the folder 120 is rotated further (by 180 degrees), the rotary shaft 40 is rotated again as shown in FIG. 8A and FIG. 8B, and the protrusion 41a formed on the rotating cam 41 and the protrusion 31 of the cam member 30 are arranged to cross each other again, so the rotating cam 41 and the cam member 30 are closely arranged to each other again. Thus, due to the elastic member 20, which is compressed by a measurement of the protruding height of the protrusion 41a formed on the rotating cam 41 and the protrusion 31 of the cam member 30, the cam member 30 is moved up in a length direction of the rotary shaft 40. In this state, the inclined surface 121 of the folder 120 contacts the inclined surface 111 of the body 110. Thus, the folder 120 is inclined slightly upward with respect to the body 110, and a user may watch a moving picture or the like more conveniently.

If a user intends to close the folder 120 back to its initial state, the user may rotate the folder 120 in a direction opposite to the above rotating operation.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A rotary hinge module, comprising:
a hinge holder comprising a housing with a receiving space;
a first elastic member and a cam member disposed in the receiving space of the hinge holder; and
a rotary shaft disposed in the receiving space, the rotary shaft disposed through the first elastic member, the cam member, and the receiving space to be rotatable and vertically moveable,
wherein the rotary shaft has a rotating cam which is disposed on and corresponds to the cam member.

2. The rotary hinge module of claim 1, wherein connection members extend from sides of the housing.

3. The rotary hinge module of claim 1, further comprising a support coupled to an upper portion of the rotary shaft.

4. The rotary hinge module of claim 3, wherein the rotary shaft comprises a stopper to prevent the support from rotating in the same direction by a certain angle.

5. The rotary hinge module of claim 1, further comprising a second elastic member disposed at a lower portion of the rotary shaft and below the receiving space of the hinge holder.

6. The rotary hinge module of claim 5, further comprising a ring member disposed below the second elastic member.

7. The rotary hinge module of claim 1, wherein protrusions are disposed on each of the cam member and the rotating cam.

8. The rotary hinge module of claim 6, wherein a projection is disposed on a lower end of the rotary shaft to support the ring member and the second elastic member, through which the rotary shaft is disposed.

9. A folder type mobile communication terminal, comprising:
a body;
a folder; and
a rotary hinge module installed at a portion where the body contacts the folder, wherein the rotary hinge module comprises:
a hinge holder comprising a housing with a receiving space;
a first elastic member and a cam member disposed in the receiving space of the hinge holder; and
a rotary shaft disposed in the receiving space, the rotary shaft disposed through the first elastic member, the cam member, and the receiving space to be rotatable and vertically moveable,
wherein the rotary shaft has a rotating cam which is disposed on and corresponds to the cam member, and
wherein an upper portion of the rotary shaft is disposed in the folder to allow a folding movement and a rotating movement of the body and the folder.

10. The folder type mobile communication terminal of claim 9, wherein connection members extend from sides of the housing.

11. The folder type mobile communication terminal of claim 9, further comprising a support coupled to an upper portion of the rotary shaft and fixed in the folder to move together with the folder.

12. The folder type mobile communication terminal of claim 9, wherein contacting portions of the body and the folder, which contact each other if the folder is in a fully open or fully closed state, are configured as inclined surfaces.

13. The folder type mobile communication terminal of claim 12, wherein the inclined surfaces are inclined relative to a remaining portion of the body and a remaining portion of the folder.

14. The folder type mobile communication terminal of claim 11, wherein an end of the folder comprises a curved surface and a linear surface, a first radius is a distance from a center of the support to the linear surface, a second radius is a distance from the center of the support to the curved surface, and the second radius is greater than the first radius.

15. The folder type mobile communication terminal of claim 9, further comprising a second elastic member disposed at a lower portion of the rotary shaft and below the receiving space of the hinge holder.

16. The folder type mobile communication terminal of claim 15, further comprising a ring member disposed below the second elastic member.

17. The folder type mobile communication terminal of claim 9, wherein protrusions are disposed on each of the cam member and the rotating cam.

18. The folder type mobile communication terminal of claim 16, wherein a projection is disposed on a lower end of the rotary shaft to support the ring member and the second elastic member, through which the rotary shaft is disposed.

19. The folder type mobile communication terminal of claim 9, wherein the body comprises a stopper to prevent the folder from rotating in the same direction by a certain angle.

20. The folder type mobile communication terminal of claim 9, wherein the rotary shaft comprises a stopper to prevent the folder from rotating in the same direction by a certain angle.
